(19) United States
(12) Patent Application Publication
(10) Pub. No.: US 2007/0032185 A1
(43) Pub. Date: Feb. 8, 2007

(54) Device for cutting and stripping meat

(75) Inventors: Robert Freund, Borchen (DE); Reinhard Freund, Paderborn (DE)

Correspondence Address: BROWDY AND NEIMARK, P.L.L.C.;624 NINTH STREET, NW, SUITE 300, WASHINGTON, DC, 20001-5303, US

(73) Assignee: Freund Maschinenfabrik GmbH & Co. KG, Paderborn (DE)

(21) Appl. No.: 10/568,870

(22) PCT Filed: Aug. 14, 2004
(86) PCT No.: PCT/EP04/09147

§ 371 Date: Oct. 13, 2006

(30) Foreign Application Priority Data
Aug. 21, 2003 (DE) 103 38 336.0
May 13, 2004 (DE) 10 2004 024 077.9

(51) Int. Cl. A22C 25/00

(52) U.S. Cl. 452/149

(57) ABSTRACT

The invention relates to a device for cutting and stripping meat (1), said device being used to divide up an animal product (28) to be cut. Said device comprises a cutting bench (2) that is mounted on a trestle (3) and a circular blade (6) that is mounted on said bench. A motor (10), which is equipped with a gear (11) that is attached to a flange, is connected to a rotating shaft (12) to produce the drive and is positioned above the rotating shaft (12) on one side on a pivoting arm (8), which is fixed to the trestle in a discharge zone (2A) behind the circular blade (6). Said pivoting arm is narrow (8), extends in approximate alignment with the circular blade (6) and is mounted on the trestle (3) by means of a pivoting articulation (19) that is fixed to the cutting bench (2). The pivoting actuator (29) of the pivoting arm (8) is a spindle drive (29), which is connected in an articulated manner to the pivoting arm (8). A gap wedge is provided in the region between the pivoting arm (8) and the circular blade (6), said wedge being adjusted to produce a narrow gap, thus almost completely filling said region.

The invention relates to a device for cutting and stripping meat, said device being used to divide up an animal product to be cut, comprising a cutting bench that is mounted on a trestle and a circular blade that is mounted on said bench, turning in a vertical plane around a rotating shaft, its depth of cut adjustable by means of a pivoting adjustment, wherein a motor with a flanged gear is connected to the rotating shaft to produce the drive, said motor being positioned laterally above the rotational axle on a pivoting arm, which is fixed to the trestle in a discharge zone behind the circular blade.

Such a device is known from the patent DE 295 17 636 C2. Handling of the height adjustment of the described device is inconvenient and therefore dangerous. Also, the machine support extends rather broadly into the discharge zone for the already cut-up meat and thus does not allow a swift working process. From this patent are also known a feeding carriage and guard plates. Also known is a stop for the material to be cut.

Furthermore, a device of that kind is known from DE 295 21 981 U1. This device was only of limited use for cutting up bigger animals such as sheep or hogs, since the circular blade extended about 20-30 cm into the meat discharging area. Moreover, there was a gap between the circular blade and the pivoting arm, so the access to the blade rim was unprotected. Besides, the cut material had to be discharged by pushing it over the cutting bench, which sometimes required the help of a second person, depending on the conditions.

Division of animal carcasses hung from overhead conveyors or the like, including, in particular, cleaving the sternum, cutting off horns, head, legs, footers and toes, opening the collarbone, halving or cleaving the carcass, and stripping ribs, is done with motorized disk saws, that are operated by hand or by a robot arm. Such disk saws are known from the catalogue: FREUND, Katalog 2003/2004, pages 8, 10-16, 20, 22-24. The geared motor, to the axle of which the circular blade is flanged, is equipped with two handles, and possibly with a suspension eye and/or a coupling for a robot. The disk saw produces cuts with rough edges, significant loss of material occurs, and the sawdust from the bones contaminates the meat in an undesirable way.

The hanging animal carcass, providing only a moderate counterbalance to transversal forces, often yields to linear cuts, which are supposed to conduct axially through bones, e.g. the sternum. Manual operation of the disk saw requires a relevant force, especially since the carcass is usually cooled down to 1-2° C., except during slaughter.

It is the object of the invention to provide a device for cutting and stripping meat on a cutting bench, without the disadvantages of the known devices for cutting meat listed above. Furthermore, an advantageous quality of the cuts and a long edge life of the cutting tool is to be achieved, also for a device for dividing hanging animal carcasses, with improved reliability regarding the run of the cut, and easier handling.

This object is met in such a way that the pivoting arm is narrow, and extends in, at least approximate, alignment with the circular blade, and is mounted on the cutting bench on the trestle by means of a pivot articulation and is fastened by means of a restricting and/or detachable connection underneath the cutting bench, and that a gap wedge is provided in the region between the pivoting arm and the circular blade, said wedge being adjusted to produce a narrow gap, thus almost completely filling said region.

Regarding the dividing of hanging animal carcasses, the object is met in such a way that the housing of the cutting device is disposed on a robot and/or comprises at least one handle and a suspension eye, the latter being positioned approximately above the centre of gravity.

Advantageous embodiments of the invention are presented in the subclaims.

A discharge of the cut off material without accumulation is achieved by positioning the narrow pivoting arm, supporting the motor, the gear and the circular blade, in the advance direction, and by providing the gap wedge in the region between the circular blade and the pivoting arm.

Preferably, roller conveyors or a band conveyor are arranged on the cutting bench, passively or actively facilitating the discharge of cut material.

On the feeding side, a roller conveyor or a band conveyor can also be provided, if a feeding carriage is not sufficient.

The feeding carriage can comprise a slit recess receiving the circular blade, a feeding edge for the cut-off piece, and a variety of receiving troughs.

All feeding and discharge equipment, such as the feeding bench, roller conveyors, band conveyors, the stop for material to be cut, are pivoted on the side of the trestle, so that easy cleaning and quick adjustment to changes of material to be cut are made possible.

The trestle comprises height-adjustable feet, permitting to adjust it to varying heights of operators, and possibly of feeding and discharge conveyors. The trestle and the drive for the circular blade are set up for right-hand and left-hand mounting, so that the device can easily be integrated in different production lines.

An advantageous blade protector, largely enclosing the circular blade, comprises an edging, which consists of concavely profiled synthetic material structured in segments, which efficiently prevents contact with circular blades of varying diameters, which decrease due to regrinding.

Circular blades are approved for dividing up meat, since losses are extremely small. For dividing sheep, pigs or the like into front and back halves, in the course of which bones also have to be divided, a circular blade is similarly approved, featuring a blade continuously tapered from the mounting flange towards the wedge-shaped edge of the blade.

Operation of the manual device shows that the circular blade can be lead through the object attaining a desired cutting direction much easier than the known disk saws, and also a lesser force needs to be applied. This is due to the steadier position of the object resulting from a lesser transversal force.

The cutting speed of the perimeter of the circular blade is determined by the diameter of the blade and by the rotational speed in such a way, that during a swift working process an even cutting face of the meat is produced, and bones are smoothly divided, thus minimizing incipient fractures.

The diameter ranges between 100 and 1000 mm. A smaller diameter is chosen for works that involve entering the animal carcass, than for works that take place solely on the outside.

The rotational speed is determined, on one hand by the speed-reducing gear, and on the other hand by the alternating current, which is supplied to the motor either directly by a mains supply, via an extra-low voltage transformer, or by a controllable frequency converter.

The circumferential speed of the circular blade is chosen lower than 3 km/min, because otherwise burns can occur and the cut edges are damaged. On the other hand, it is not advisable to choose a very low cutting speed, which causes the bones to splinter. Principally, a much lower cutting speed than that of a disk saw blade is optimal, since the material is clean cut and not machined.

Advantageously, the circular blade features an asymmetrical grinding for cutting off slices.

A symmetrical grinding of the circular blade, preferably slightly serrated, facilitates precise cuts when dividing parts of the carcass.

The edge life of the circular blade is several times higher than that of a disk saw blade under the same conditions, due to its easier impact on the material. This increase of tool life reduces set-up and maintenance time.

For the different dividing processes, such as

dividing the sternum,

cutting off horns,

cutting off legs, footers, toes,

dividing the collarbone,

halving a carcass,

taking off neck and head,

cutting ribs,

quartering,

different blade diameters, handle arrangements and guard plate arrangements are chosen, according to the standards of the known disk saw method, thus resulting in an adapted depth of cut, e.g. 85 mm for dividing the sternum, and a favourable position of the operator's arms and hands.

The mounting flange of the circular blade is shaped as flat as possible and without edges or corners, so the cut material can slide by laterally without inhibition.

A buckling arm robot can advantageously support the device. Preferably, the mounting is designed with an automatic locking, which is actuated when the robot arm has positioned its coupling correctly in a complementary coupling in the housing. Advantageously, the coupling is released by actuating a releasing device by means of a computer-controlled electromagnet or a mechanically actuated lever, the latter being advantageously actuated also by a robot motion.

To optimise the run of the cut, preferably tactile sensors, which are linked to the computer control, are arranged next to the circular blade. Advantageously, the frequency converter is also controlled by the computer control, to optimise cutting speed according to the respective type of cut.

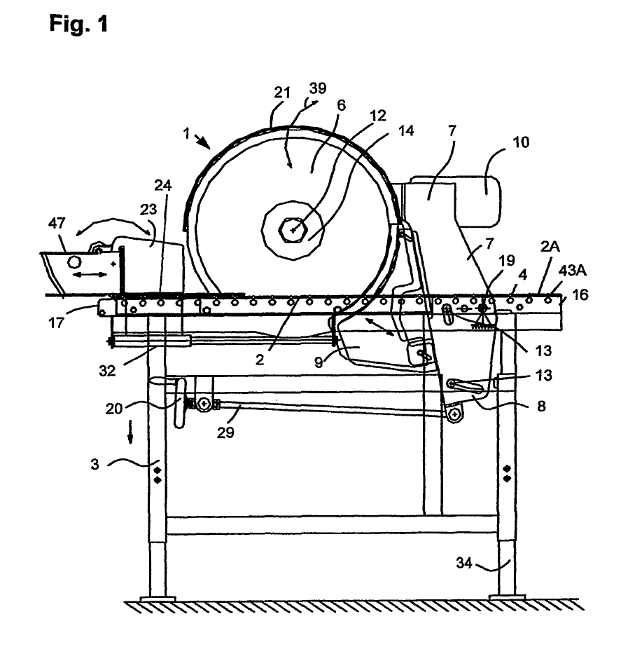

Advantageous embodiments are described in the FIGS. 1-4.

FIG. 1 shows a side view of the cutting device

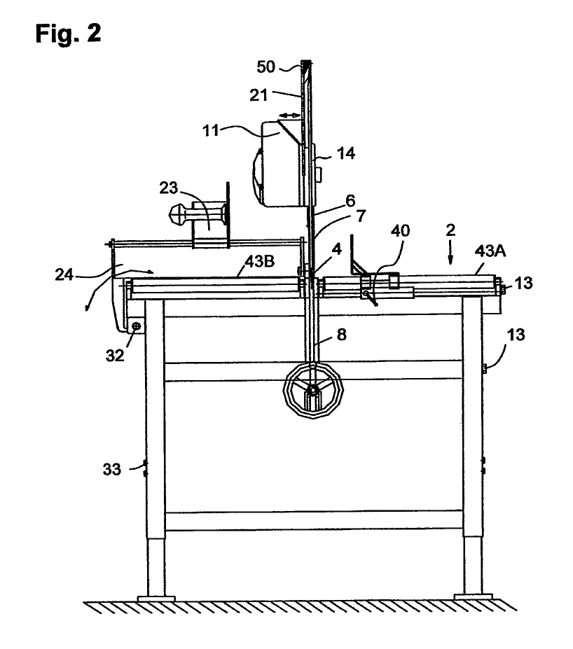

FIG. 2 shows a front view of the cutting device

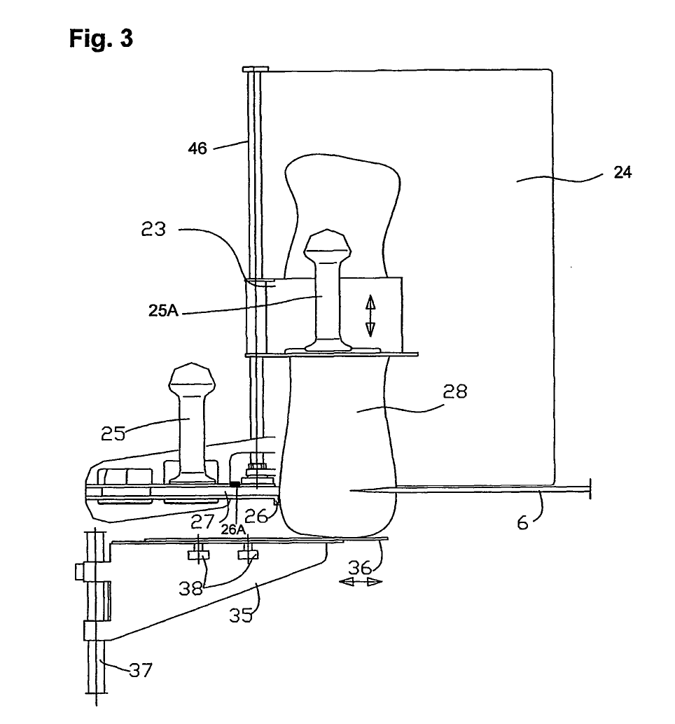

FIG. 3 shows a detail of the feeding side

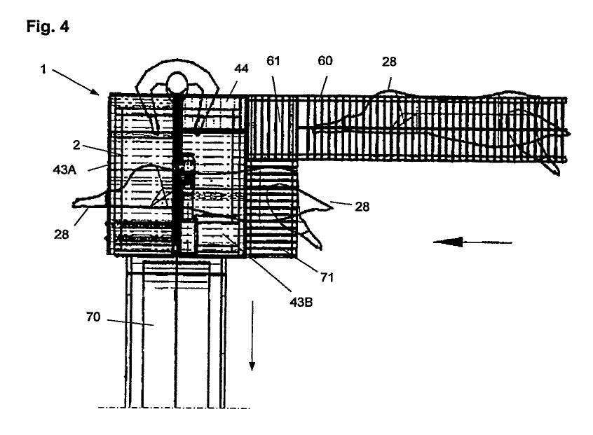

FIG. 4 shows a top view of a production line layout

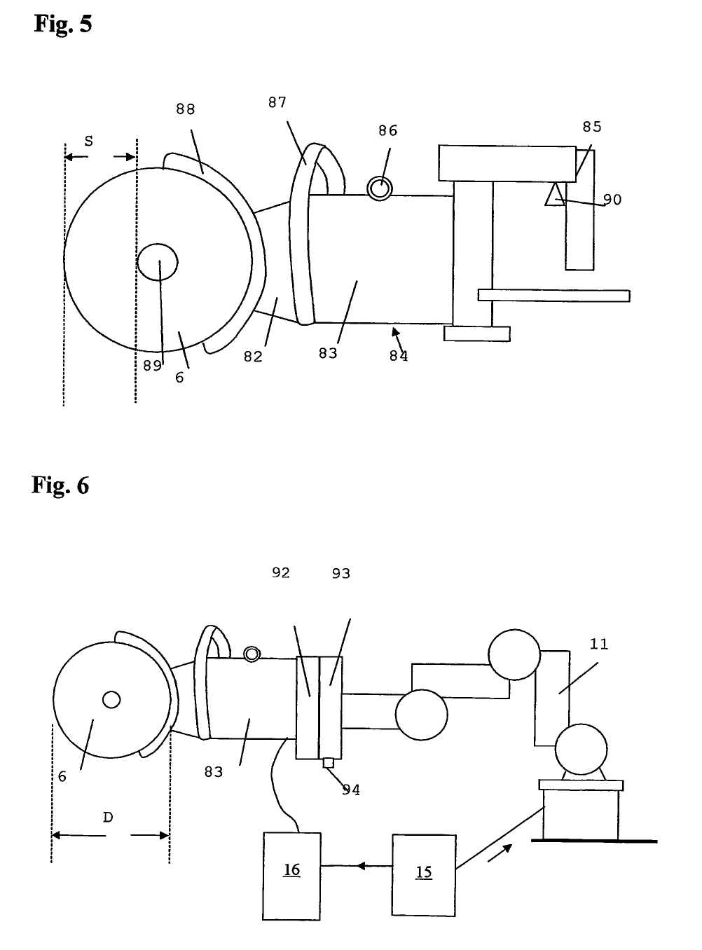

FIG. 5 shows a device for manual operation

FIG. 6 shows a device actuated by a robot

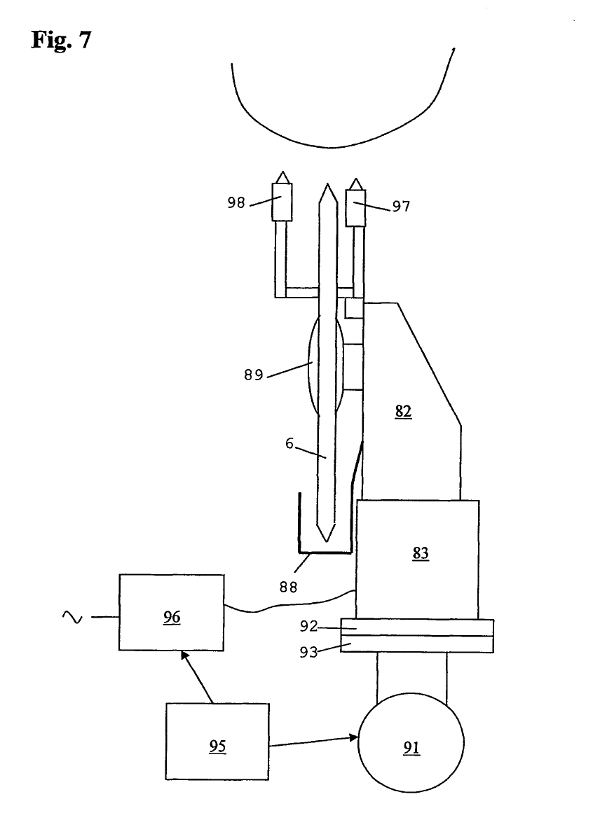

FIG. 7 shows a top view of FIG. 6

FIG. 1 shows a trestle 3 with locking screws 33, height-adjustable feet 34 and a cutting bench 2. A cutting device 1, consisting of a circular blade 6, protrudes into the bench. The centre of said blade is fixed on a driving axle 12 by means of a flange 14, said axle being driven by a gear with a motor 10 on top. The motor 10, the gear 11 and the circular blade 6 are maintained on an upper mounting end 7 of a pivoting arm 8, on the discharge side of the device. Said pivoting arm is narrow, and extends in the direction of the circular blade 6 in at least approximate alignment with the latter, and is mounted on the trestle 3 by means of a pivot articulation 19. The pivoting arm 8 extends into the trestle 3, and is clamped to it, at about half its height, by means of attachment screws 13, which are positioned in circarc cutouts. The lower end of the pivoting arm is coupled to a threaded spindle, which is maintained in a mating thread on the front of the trestle 3 and is equipped with a hand wheel accessible from the front. The attachment screws 13 extend to the side of the trestle 3, so they can easily be slackened and fastened, in order to adjust the angle, relative to the surface of the bench, by which the circular blade 6 is inserted.

A gap wedge 9 is provided in the region between the pivoting arm 8 and the perimeter of the circular blade 6, said wedge being adjusted to leave a narrow gap towards the blade 6.

The surface 4 of the cutting bench 2 is covered with a roller conveyor 43A. A feeding carriage 24, with a slider 23 and a trough 47 for the material to be cut 28, is provided on the cutting bench 2, pivoted in a laterally turnable manner on a guide rod 32, which is attached to the side of the trestle 3.

A blade protector 21 on top and on the feeding side encloses the circular blade 6.

The advance direction extends from the operating side 17 via the discharge zone 2A to the rear side 16 of the bench. The arrow 39 indicates how the inclination can be adjusted.

FIG. 2 shows a front view of the dividing device. The median division 18 of the cutting bench 2 and the roller conveyors 43A,43B, positioned on both sides of the bench top, are visible. The driving axle 12 of the circular blade 6 extends into the gear 11, which is maintained on the narrow pivoting arm 8, 7 above the cutting-operating zone. The blade protector 21 encloses the circular blade 6 on top of the gear. The frontal part of the blade protector has been taken off, so the radially adjustable segments 50 of synthetic material, that are positioned inside, at the perimeter, are visible.

On the left side of the picture, besides the circular blade 6, the feeding carriage 24 can be seen. It is guided by, among others, the guide rod 32, in the cutting- and advance direction. A guide rod 46 is attached to the feeding carriage 24, transversal to the advance direction, maintaining a transversal slider 23, which is equipped with a handle 25. The slider is pivoted, so it can be folded away to the front and comes into use particularly when the material to be cut 28 is supposed to be advanced little by little or when the slider 23 is used to hold down the material to be cut 28, as it is shown in the picture.

The feeding carriage 24 also features a handle 25, and a slit recess, or pocket 27, into which the circular knife 6 is inserted when the carriage is advanced. A feeding edge 26 is provided on the side of the recess 27 opposed to the handle 25, further advancing the cut off material.

On the right side of the picture, at the side of the circular blade 6, a guide rod 37 is mounted on the trestle 3, transversal to the advance direction, supporting a slidable stop 35, fixable by means of the toggle 40. A longitudinally slidable stop plate 36, is maintained on the stop 35, fixable by means of attachment screws 38. Corresponding details are shown in FIG. 3, in a top view of the slidable structural components 24, 23, and 35.

FIG. 4 shows an outlay of the device 1, in a production line with a feeding conveyor and a discharge conveyor 60, 61, 70. The material to be cut 28 proceeds from the feeding conveyor 60 via a short adapting conveyor 61 on the left side of the operator onto a narrow transversal conveyor 44 on the cutting bench 2, so the operator can easily advance the object to and across the cutting slot. Then he pushes it via the roller conveyors 43A, 43B, oriented in the direction of discharge, and the shouldering conveyor 71, onto the discharge band conveyor 70. The conveyors can be equipped with passively or actively driven rollers or with chain drives.

FIG. 5 shows a side view of a dividing device, expedient for parting the sternum of pigs, which is usually located in a low working position.

The circular blade 6 is flanged to an angular gear 82, which, together with an electric motor 83, is positioned in a housing 84. A guard plate 88 is attached to the housing 84 on the side of the motor, the front and bottom area of the blade 6 are completely exposed. A guide finger, standard for a sternum disk saw, is obsolete, therefore handling is facilitated, since no interlocking can occur.

A suspension eye 86 is attached to the housing 84, approximately above the centre of gravity, to provide weight relief during operation.

A handle 85 is provided on the rear side of the housing 84. For the division of the sternum, for example, it is inclined, due to the low working position. In an opening of the handle, a hand switch 90 for the motor 80 is comprised in the handle, to control the motor current. A bow-type handle 87 is attached in front of the eye 86, partly encompassing the housing 84, so it can be gripped from the top and from the side. Preferably, the diameter of the circular blade 6 measures 250 to 280 mm, so the depth of cut S, resulting from the distance of the blade perimeter to the flange 89 at the hub of the blade, measures at least 85 mm.

FIG. 6 shows a buckling arm robot 91, which is connected to the housing 84 of the cutting device by means of a coupling 92 locked to a complementary coupling 93. The robot 91 is linked to a computer control 95 in the known manner. By actuating a release button 94 on the coupling 22,93, it can be released and detached, and the cutting device can be put down.

Preferably, tactile sensors 97, 98 are positioned on the housing 84 on both sides of the circular blade 6, the tactile signals of which are delivered to a computer control 95, so the circular blade 6 can perform a central cut, traversing a prominent area of, e.g., a sternum.

A frequency converter 96, employed instead of an extra-low voltage transformer, triggers the three-phase motor 83, said frequency converter receiving a control signal from the computer control 95, which determines the frequency.

In an analogous way, the construction of dividing disk saws, collarbone disk saws, horn disk saws can be altered, wherein the respective construction has to provide a circular blade of an adequate diameter, a guard plate adapted to the blade, matching guiding devices if necessary, ergonomically positioned handles, and a gear with a greater reduction ratio than those used with analogous disk saws. If robots are employed, the guard plate and the handles are obsolete.

### REFERENCE SIGNS

1 device for cutting meat
2 cutting bench
2A discharge zone
3 trestle
4 cutting bench-surface
6 circular blade
6A blade edge
7 mounting
7A mounting, upper end
8 pivoting arm
9 adjustable gap wedge (protection against accidental contact)
10 electric motor
11 gear
12 rotating shaft
13 attachment screws
14 flange
16 rear side of bench
17 operating side
18 slit in
19 pivoting actuation regulating depth of cut
20 hand wheel regulating depth of cut
21 blade protector
23 slider/pivoted pressure pad
25 handle
26 feeding edge
26A hand guard plate
27 pocket/slotted receiver
28 material to be cut
29 pivoting actuator/spindle drive
32 carriage guide
33 locking screw
34 height-adjustable feet
35 stop for material to be cut
36 longitudinally adjustable stop
37 guide rod
38 attachment screws
39 regulation of depth of cut
40 locking screw
43A roller conveyor
43B roller conveyor
44 transverse roller conveyor
45A trough-shaped zone
46 crossbar
47 trough
50 segmental edging made of synthetic material
60 feeding conveyor
61 discharge conveyor
70 discharge conveyor
71 shouldering conveyor
82 angular gear
83 electric motor
84 housing
85 operating handle
86 suspension eye
87 bow-type handle
88 guard plate
89 flange
90 hand switch
91 robot
92 coupling
93 complementary coupling
94 release button
95 computer control
96 frequency converter
97 tactile sensor
98 tactile sensor
D diameter of circular blade
S depth of cut

1-29. (canceled)

30. Device for cutting and stripping meat (1), said device being used to divide up an animal product (28) to be cut, comprising a cutting bench (2) that is mounted on a trestle (3) and a circular blade (6) that is mounted on said bench, turning in a vertical plane around a rotating shaft (12), its depth of cut adjustable by a pivoting adjustment (29), wherein a motor (10) with a flanged gear (11) is connected to the rotating shaft (12) to produce the drive, said motor being positioned laterally above the rotational axle (12) on a pivoting arm (8), which is fixed to the trestle in a discharge zone (2A) behind the circular blade (6), characterized in that
the pivoting arm (8) is narrow, and extends in, at least approximate, alignment with the circular blade (6), and
is mounted on the cutting bench (2) on the trestle (3) by means of a pivot articulation (19) and is fastened by means of a restricting and/or detachable connection underneath the cutting bench (2),
and that
the pivoting actuator (29) of the pivoting arm (8) is a spindle drive (29), which is connected in an articulated manner to the pivoting arm (8), and can be manipulated from the operating side (17) of the cutting bench (2),
and that a gap wedge (9) is provided in the region between the pivoting arm (8) and the circular blade (6), said wedge being adjusted to produce a narrow gap, thus almost completely filling said region.

31. Device for cutting meat, according to claim 30, characterized in that the spindle drive (29) can be actuated by means of a hand wheel (20).

32. Device for cutting meat, according to claim 30, characterized in that the pivoting arm (8) is connected to the trestle (3) by means of attachment screws (13) passing through circarc cut-outs, arranged in a concentric manner around the pivot articulation (19), the heads of the screws extending to the edges of the trestle (3).

33. Device for cutting meat, according to claim 30, characterized in that on the cutting bench (2) a feeding carriage (24) with a handle (25) is maintained in a slidable manner, said carriage featuring a slit recess (27), through which passes the circular blade (6) when it is advanced, and to the side of which are arranged at least one hand guard plate (26A) and, if necessary, besides the handle (25), a feeding edge (26) for the material to be cut (28).

34. Device for cutting meat, according to claim 33, characterized in that the cutting bench (2) or the feeding carriage (24), on one or both sides of the circular blade (6), are each covered with a roller conveyor (43A, 43B) or with a band conveyor.

35. Device for cutting meat, according to claim 33, characterized in that the feeding carriage (24) is guided, on one side, by means of a guide rod (32), which is mounted laterally on the trestle (3), and that said carriage, pivoted on the guide rod, can be turned either onto the cutting bench (2) or into a hanging position at the side of the bench.

36. Device for cutting meat, according to claim 33, characterized in that the feeding carriage (24) has a trough (47) receiving the material to be cut (28), on one or both sides of the slit recess (27), or that an area near the recess is shaped as a through, and/or that the width of the slit recess (27) in the feeding carriage (24) is variable, depending on the material to be cut.

37. Device for cutting meat, according to claim 36, characterized in that a crossbar (46) is mounted on the front of the feeding carriage (24), maintaining, in a slidable and pivoted manner, a slider and holder (23) with a handle (25A).

38. Device for cutting meat, according to claim 33, characterized in that a horizontal guide rod (37) is mounted on the front side of the trestle (3), out of the way of the feeding carriage (24), maintaining a stop (35, 36) for the material to be cut (28) in a slidable and fixable manner, which is also pivoted and can be positioned on the cutting bench (2).

39. Device for cutting meat, according to claim 30, characterized in that the perimeter of the circular blade (6) features a symmetrical serrated grinding, or an asymmetrical grinding.

40. Device for cutting meat, according to claim 39, characterized in that the circular blade (6) comprises a centred mounting flange (14) with a radially decreasing thickness, tapered towards a sharp edge (6A).

41. Device for cutting meat, according to claim 30, characterized in that the circular blade (6) is enclosed by a sector-shaped blade protector (21), which comprises an edging, positioned in an area bordering the edge of the blade (6A), which consists of concavely profiled synthetic material structured in segments (50), and can thus be radially adjusted to closely fit different diameters of circular blades.

42. Device for cutting meat, according to claim 34, characterized in that at least one of the roller conveyors (43A, 43B) comprises loose or driven rollers.

43. Device for cutting meat, according to claim 34, characterized in that a transverse roller conveyor (44), with longitudinally oriented rollers, is positioned in an operating zone on the cutting bench (2).

44. Device for cutting meat, according to claim 34, characterized in that the roller conveyors (43A, 43B, 44) are mounted on the trestle (3) in a pivoted and detachable manner.

45. Device for cutting meat, according to claim 38, characterized in that the feeding carriage (24), the stop (35, 36), the motor (10) with the gear (11), and the blade protector (21) can be arranged on the trestle (3), which has been adequately prepared, in a right-hand or left-hand manner.

46. Device for cutting meat, according to claim 30, characterized in that the motor (80), driving the circular blade (6), is powered by a controllable frequency converter (96) or by an extra-low voltage transformer.

47. Device for cutting meat, according to claim 46, characterized in that the diameter (D) of the circular blade (6) ranges between 100 and 1000 mm, and that the circular blade (6) is driven with a cutting speed below 3 km/min, and, due to a speed-reducing gear pair and/or a respective frequency conversion, has a rotational speed of 50 to 1000 rpm.

48. Device for cutting meat, according to claim 47, characterized in that a computer control (95) controls the frequency converter (96) regarding frequency and on/off switching.

49. Device for cutting meat, according to claim 30, characterized in that a tactile sensor (97, 98) is positioned on one or, respectively, on both sides of the circular blade (6), the signal of which is delivered to a computer control (95), the latter actuating a robot (91) by means of the tactile signals or a tactile signal, which guides the circular blade (6) to traverse a prominence, e.g. a sternum, centrally.
